(19) United States
(12) Patent Application Publication
(10) Pub. No.: US 2014/0046929 A1
(43) Pub. Date: Feb. 13, 2014

(54) IMAGE CAPTURE DEVICE and IMAGE CAPTURING METHOD

(71) Applicant: FUJITSU LIMITED, Kawasaki-shi (JP)

(72) Inventor: Yumiko NAKAMURA, Kawasaki (JP)

(21) Appl. No.: 13/946,763

(22) Filed: Jul. 19, 2013

(30) Foreign Application Priority Data
Aug. 7, 2012 (JP) 2012-175296

(51) Int. Cl. G06F 17/30

(52) U.S. Cl. CPC G06F 17/30991
USPC 707/722

(57) ABSTRACT

A processor specifies an application to be recorded based on timing with which the application is activated, and detects a specified operation for the application to be recorded. The processor generates image data on a display screen each time the specified operation for the application to be recorded is detected, associates the generated image data with the application to be recorded, and stores the data as record information in a storage unit. The processor extracts from one or more pieces of record information stored in the storage unit the record information associated with the detected application upon detection of activation of the application, and lists the record information; and a display processing unit which displays image data included in any record information in the listed record information.

### CROSS-REFERENCE TO RELATED APPLICATION

This application is based upon and claims the benefit of priority of the prior Japanese Patent Application No. 2012-175296, filed on Aug. 7, 2012, the entire contents of which are incorporated herein by reference.

### FIELD

The embodiments discussed herein are related to an image capture device, an image capturing method, and a program for the device and the method.

### BACKGROUND

Conventionally known is a tool for automatically capturing a display screen with arbitrary timing. For example, some Windows (registered trademark) known as an operating system(OS) provides a tool referred to as a problem step recording tool which automatically captures a display screen depending on the operation of a user. Using the tool, a user may record an operation to be performed on a specific application as a captured image, and later perform the operation by referring to a captured image.

Recorded data which stores an operation procedure etc. after capturing an operation screen using a tool such as the problem step recording tool etc. is stored in a specified folder using a file in a specified form with an appropriate file name assigned. However, when a large volume of recorded data is stored, a user is to search the large volume of data for specific recorded data.

Relating to the technology above, well-known is an information processing device which enables a user to easily find an icon etc. of a specific application and file. When an icon is specified by a mouse, the information processing device pop-ups from an icon the screen image associated with the specified application corresponding to the specified icon. In this case, the information processing device also pop-ups from the icon corresponding to a related application a screen image associated with the application related to the application corresponding to the specified icon.
[Patent Document 1] Japanese Laid-open Patent Publication No. 2008-158883

### SUMMARY

According to an aspect of the embodiments, an image capture device includes a processor.

The processor specifies an application to be recorded based on timing with which the application is activated, and detects a specified operation for the application to be recorded.

The processor generates image data on a display screen each time the specified operation for the application to be recorded is detected, associates the generated image data with the application to be recorded, and stores the generated image data and the application to be recorded as record information in a storage unit.

The processor extracts from one or more pieces of record information stored in the storage unit the record information associated with the detected application upon detection of activation of the application, and lists the record information.

The processor displays image data included in any record information in the listed record information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view of the outline of an image capture device according to an embodiment of the present invention.

FIG. 2 is an explanatory view of the outline of an image capturing process by an information processing device 1200 according to the embodiment.

FIG. 3 is an explanatory view of the outline of a displaying process of a captured image by the information processing device 1200.

FIG. 4 is an explanatory view of the outline of an image capturing process which provides an automated event activating function.

FIG. 5 is an explanatory view of the outline of a displaying process of a captured image which provides an automated event activating function.

FIG. 6 is an example of an operation screen of an image capturing tool.

FIG. 7 is an example of a folder storing operation record information.

FIG. 8 is an example of a folder when an automated event activation flag is effective.

FIG. 9 is an example of a listing display screen of operation record information.

FIG. 10 is an example of a total display screen 1000 which listing all operation record information.

FIG. 11 is an example of a setting screen of an automated event activation flag.

FIG. 12 is an example of a configuration of an information processing device 1200.

FIG. 13 is an explanatory view of the outline of a system configuration of an information processing device 1200.

FIG. 14 is an explanatory view of an example of a configuration of operation record information recorded by an information processing device 1200.

FIG. 15 is a flowchart of an example of an image capturing process by an information processing device 1200.

FIG. 16 is an example of a displaying process of operation record information by an information processing device 1200.

FIG. 17 is an explanatory view of a configuration example of a log file when the log file is included in operation record information recorded by an information processing device 1200.

FIG. 18 is a flowchart of an example of a process performed when an operation log is acquired by the information processing device 1200 simultaneously with or separately from the image capturing process.

FIG. 19 is a flowchart of an example of a process performed when an operation log is acquired by the information processing device 1200 simultaneously with or separately from the image capturing process.

FIG. 20 is a flowchart of an example of a displaying process of operation record information including at least one of a captured image and an operation log.

FIG. 21 is a flowchart of an example of a displaying process of operation record information including at least one of a captured image and an operation log.

### DESCRIPTION OF EMBODIMENTS

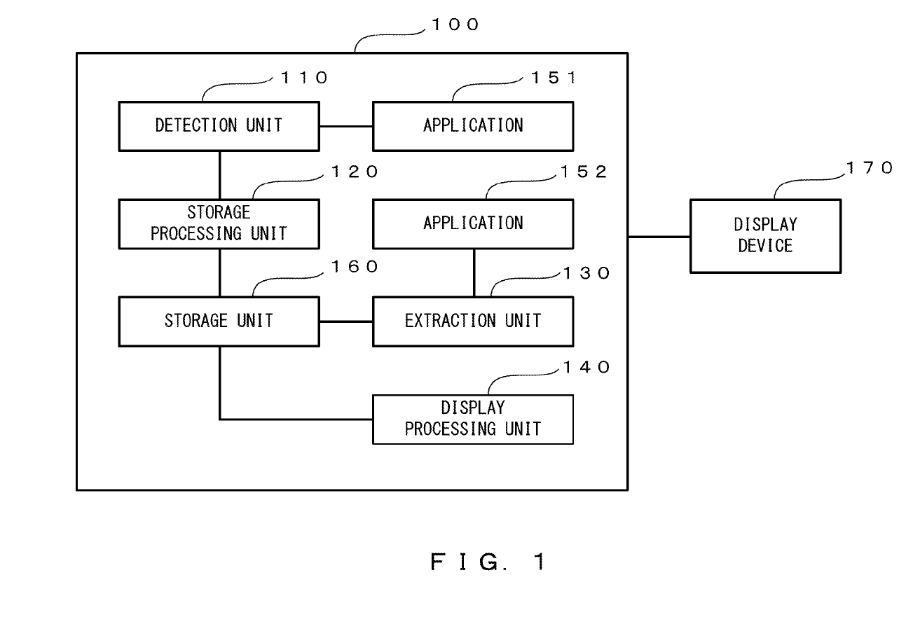

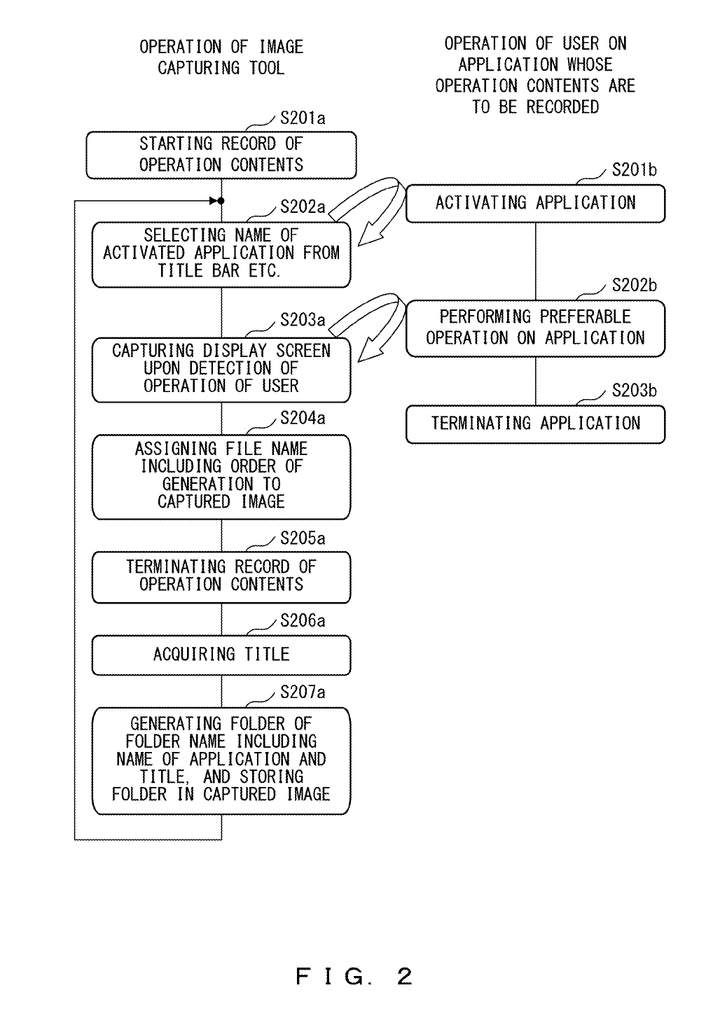

An example of an embodiment of the present invention is described below with reference to FIGS. 1 through 21. The embodiments described below are exemplified only, and many variations and technical applications not described below are not excluded from the present invention. That is, the embodiments of the present invention may be realized in many variations by, for example, combining the processes in the embodiments within the scope of the gist of the present invention. The procedure of the processes in form of flowchart in FIGS. 2 through 5, 15, 16, and 18 through 21 is not intended for limiting the order of the processes. Therefore, it is obvious that the order of the processes may be changed as necessary.

<<Embodiments>>FIG. 1 is an explanatory view of an image capture device 100 according to an embodiment of the present invention.

The image capture device 100 according to the present embodiment includes a detection unit 110, a storage processing unit 120, an extraction unit 130, and a display processing unit 140. The detection unit 110, the storage processing unit 120, the extraction unit 130, and the display processing unit 140 maybe realized by allowing a central processing unit (CPU) of an information processing device provided with the CPU, memory, etc. to execute a specified program. The image capture device 100 may also be used by a user to perform applications 151 and 152.

The detection unit 110 specifies the application 151 to be recorded based on the timing with which an application is activated, and detects a specified operation for the application 151 to be recorded. For example, the detection unit 110 may specify as the application 151 to be recorded an application which is activated immediately before or in a specified period before the image capturing process by the image capture device 100. In addition, the specified operation for an application may include an operation for an application using an input device, for example, a mouse, a keyboard, etc. included in the image capture device 100 but not illustrated in the attached drawings.

The storage processing unit 120 generates image data of the display screen displayed on a display device 170 each time it detects a specified operation for the application 151 to be recorded. Then, the storage processing unit 120 associates the generated image data with the application 151 to be recorded, and stores the data as record information in a storage unit 160. The storage unit 160 may be a storage device such as a magnetic disk storage device etc. The storage unit 160 may be in the image capture device 100 or externally connected to the image capture device 100.

Upon detection of the activation of the application 152, the extraction unit 130 extracts the record information associated with the application 152 from one or more pieces of record information stored in the storage unit 160, and lists the information on the display device 170.

The display processing unit 140 displays the image data included in any of the record information listed on the display device 170.

Although FIG. 1 separately illustrates the applications 151 and 152, the applications may be the same or different. In addition, only the two applications 151 and 152 are illustrated in FIG. 1, which is not to limit the number of applications.

As described above, the image capture device 100 generates image data of the display screen displayed on the display device 170 each time a specified operation for the application 151 to be recorded is detected. Then, the image capture device 100 associates the generated data with the application 151 to be recorded, and stores the data as record information in the storage unit 160. Furthermore, upon detection of the activation of the application 152, the image capture device 100 extracts the record information associated with the application 152 from one or more pieces of record information stored in the storage unit 160, and lists the information on the display device 170. Only the record information relating to the application 152 is displayed in the listing. As a result, the image capture device 100 may allow a user to easily specify the specified record information, for example, the specified record information relating to the application 152 in the present embodiment from among a number of pieces of record information stored previously.

<<Other Embodiments>>FIGS. 2 through 11 illustrate the outline of the image capturing process relating to other embodiments.

FIG. 2 is an explanatory view of the outline of an image capturing process by an information processing device 1200 according to the present embodiment.

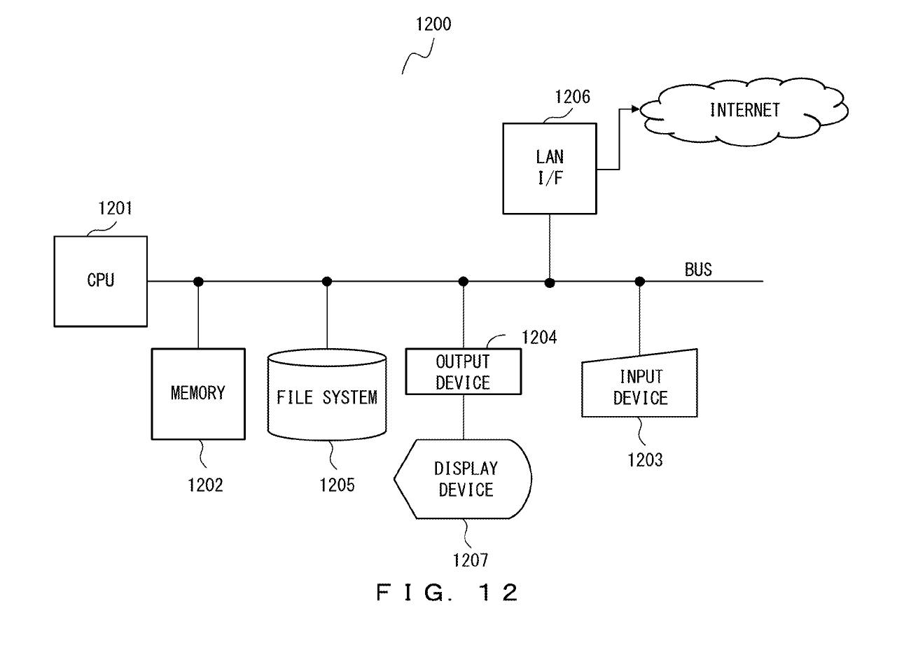

The information processing device 1200 may realize the image capturing process according to the present embodiment by executing a specified program by a CPU 1201 (processor) described later with reference to FIG. 12. The program for realizing the image capturing process according to the present embodiment is referred to below as an “image capturing tool”. FIG. 2 is a flowchart of the operation of the image capturing tool, the operation of a user for an application whose operation contents are to be recorded. The information processing device 1200 performs both the image capturing tool and the application.

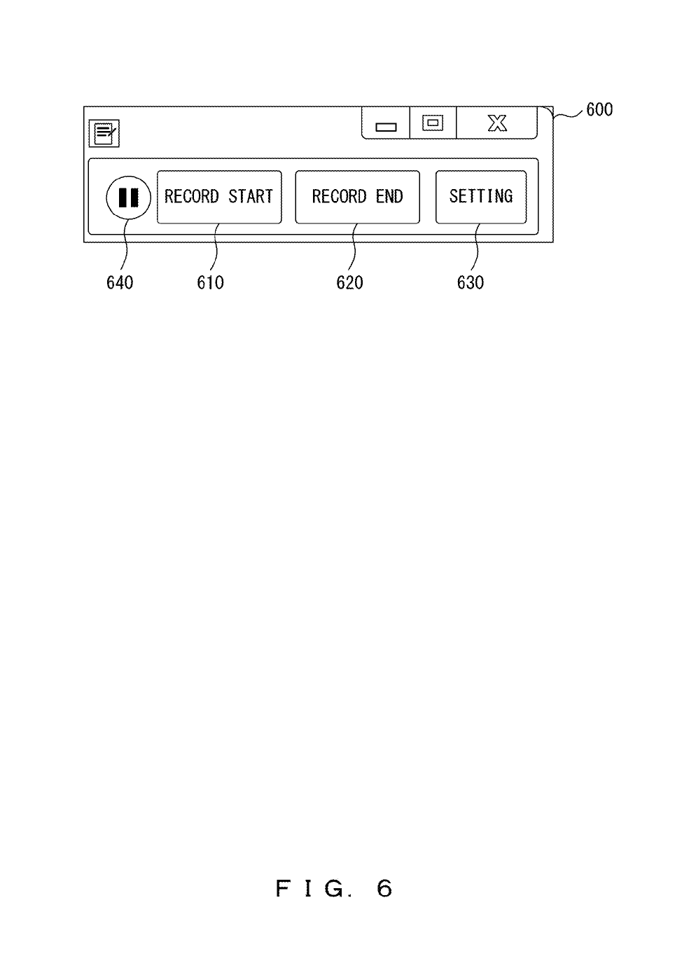

The information processing device 1200 performs the image capturing tool according to a specified operation by a user. In this case, the information processing device 1200 displays on a display device 1207 an operation screen 600 in FIG. 6 which is described later. Upon detection of the user selecting a record start button 610, the information processing device 1200 starts recording the operation contents of the user. (step S201a).

On the other hand, the user activates the application to be recorded (step S201b).

Upon detection of the activation of the application, the information processing device 1200 specifies the activated application as an application whose operation contents are to be recorded. In the description below the specified application is referred to as an “application to be recorded”. Then, the information processing device 1200 acquires the title of the application to be recorded (step S202a). The title of the application may be acquired from, for example, the title bar etc. of the window which displays the activated application. The title of the application displayed on the title bar may be acquired using the application program interface (API) provided by, for example, Windows.

On the other hand, upon activation of the application in step S201b, the user performs a specified operation on the activated application (step S202b).

Each time the information processing device 1200 detects the operation of the user, for example, the click of a mouse as an input device connected to the information processing device 1200, the information processing device 1200 captures the display screen of the display device 1207 described later (step S203a). By the capture, the information processing device 1200 generates the image data of the display screen of the display device 1207. In the description below, the image data generated by the capture is referred to as a “captured image”. The operation of the user detected by the information processing device 1200 in step S203a may include various predetermined operations such as an input operation with a specific key.

When a captured image is generated, the information processing device 1200 assigns a file name including the order of generation (step S204a). Thus, the captured image and the operation procedure of the user may be associated with each other and stored.

On the other hand, after the user performs an operation to be recorded on the application activated in step S201b, the user terminates the application (step S203b). In this case, the user selects a record end button 620 on the operation screen 600.

When the information processing device 1200 detects that the user has selected the record end button 620 on the operation screen 600, the information processing device 1200 terminates the record of the operation contents (step S205a). Then, the information processing device 1200 displays on the display device 1207 the input screen to prompt the user to input the title as the identification information about the operation contents recorded in steps S201a through S205a. When the user inputs the title, the information processing device 1200 acquires the input title (step S206b).

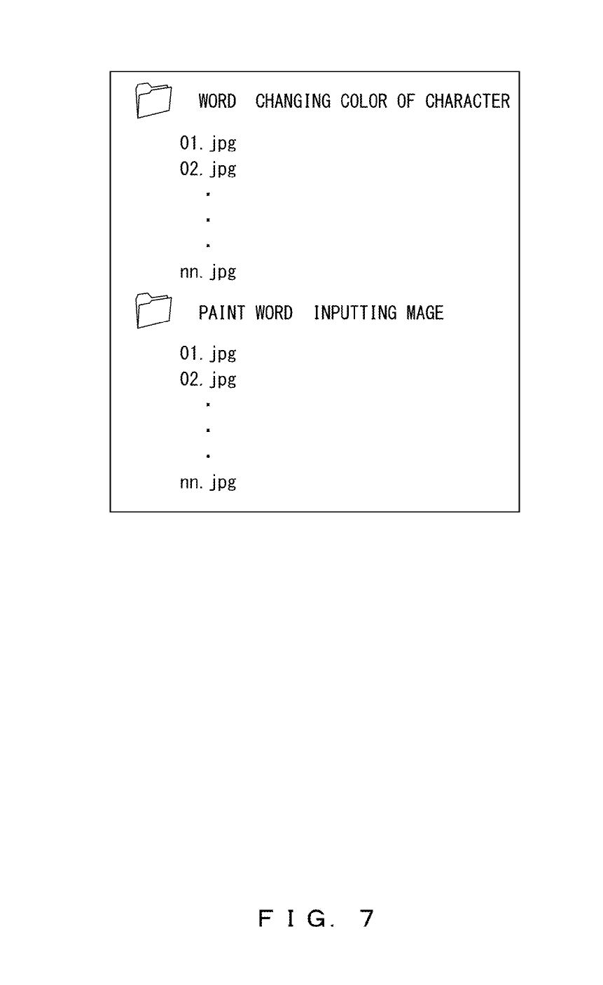

The information processing device 1200 generates a folder having the folder name including the title of the application acquired in step S202a and the title acquired in step S206a. For example, as illustrated in FIG. 7, the information processing device 1200 generates a folder having the folder name including “WORD” as the title of the application to be recorded, and “changing the color of the character” input by the user. Then, the information processing device 1200 stores the captured image acquired in the processes in steps S201a through S205a in the generated folder (step S207a). The information stored in the folder in step S207a is referred to as an “operation record information”. The operation record information may include a folder and its folder name.

When the process in step S207a is performed, the information processing device 1200 passes control to step S202a. Then, the information processing device 1200 repeats the processes in steps S202a through S207a.

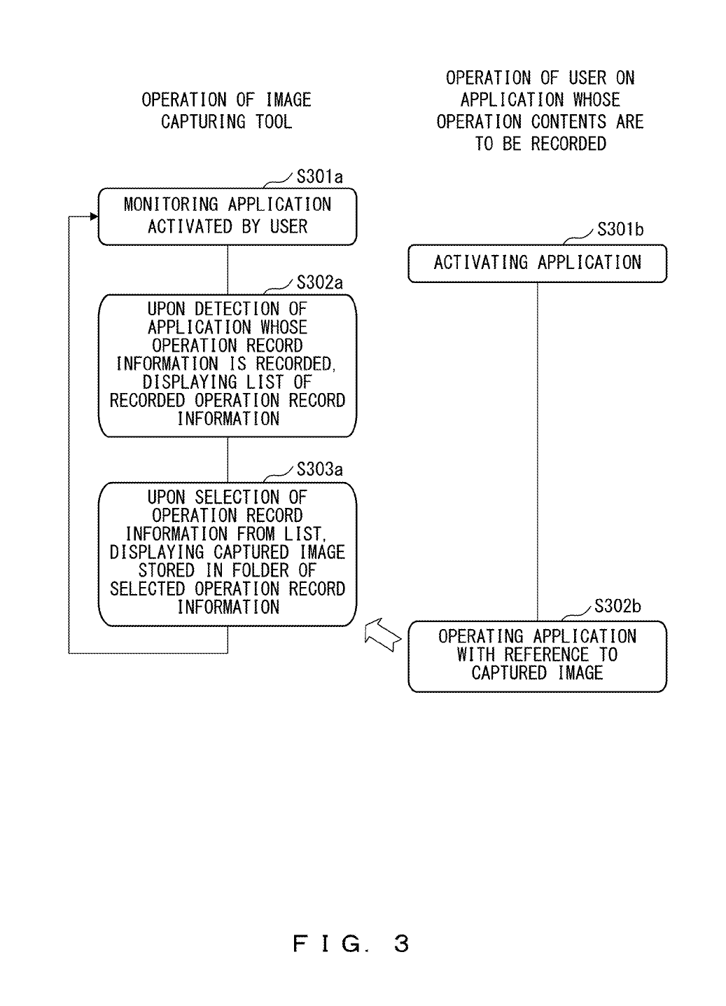

FIG. 3 is an explanatory view of the outline of a displaying process of a captured image by the information processing device 1200.

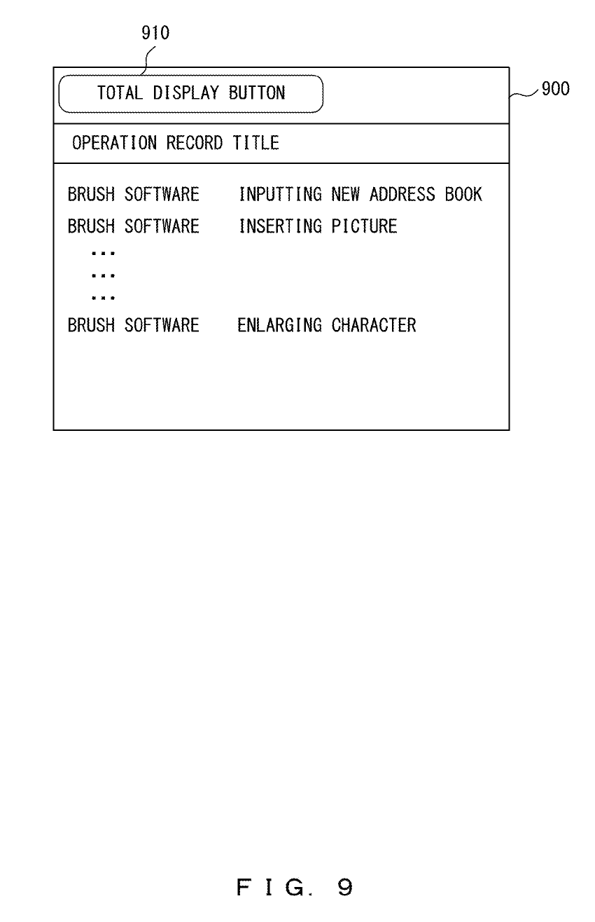

The information processing device 1200 monitors the application activated by the user according to the image capturing tool (step S301a). When the user activates the application whose operation record information is recorded (step S301b), the information processing device 1200 displays a list of the operation record information recorded for the activated application (step S302a). For example, FIG. 9 is an example of a list of the folder names of the folders storing the operation record information about brush software. In the description below, the folder name of the folder storing operation record information is referred to as an “operation record title”.

When the user selects the operation record information from the list displayed in step S302a, the information processing device 1200 displays the captured image stored in the folder of the selected operation record information (step S303a). Then, the user performs the operation of the application with reference to the captured image displayed in step S303a (step S302b).

When the process above is performed, the information processing device 1200 passes control to step S301a. Then, the information processing device 1200 repeats the processes in steps S301a through S303a.

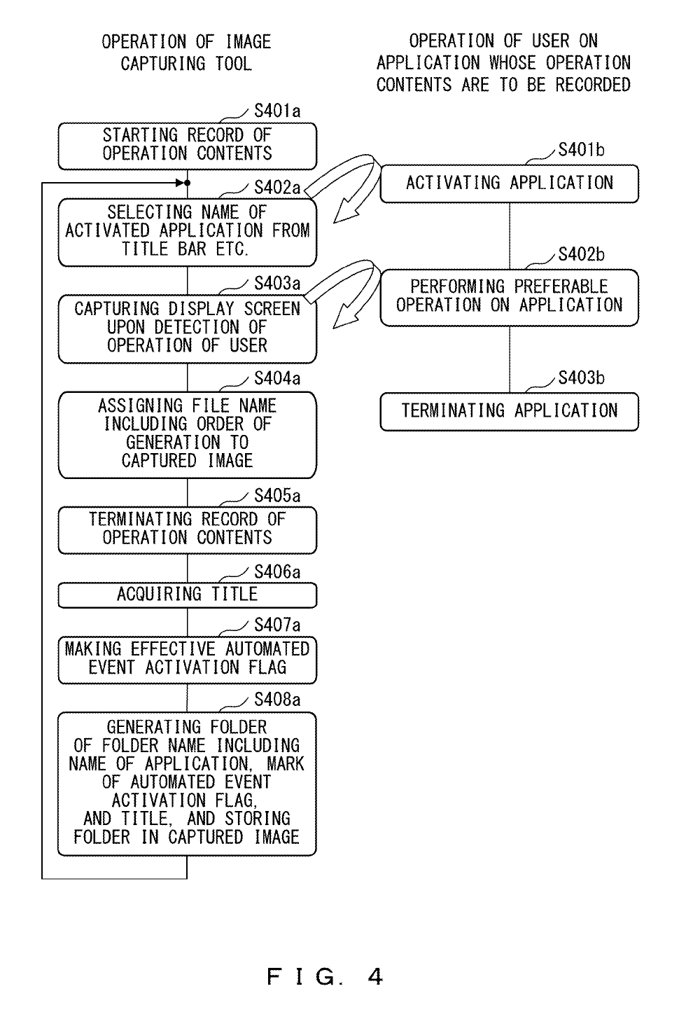

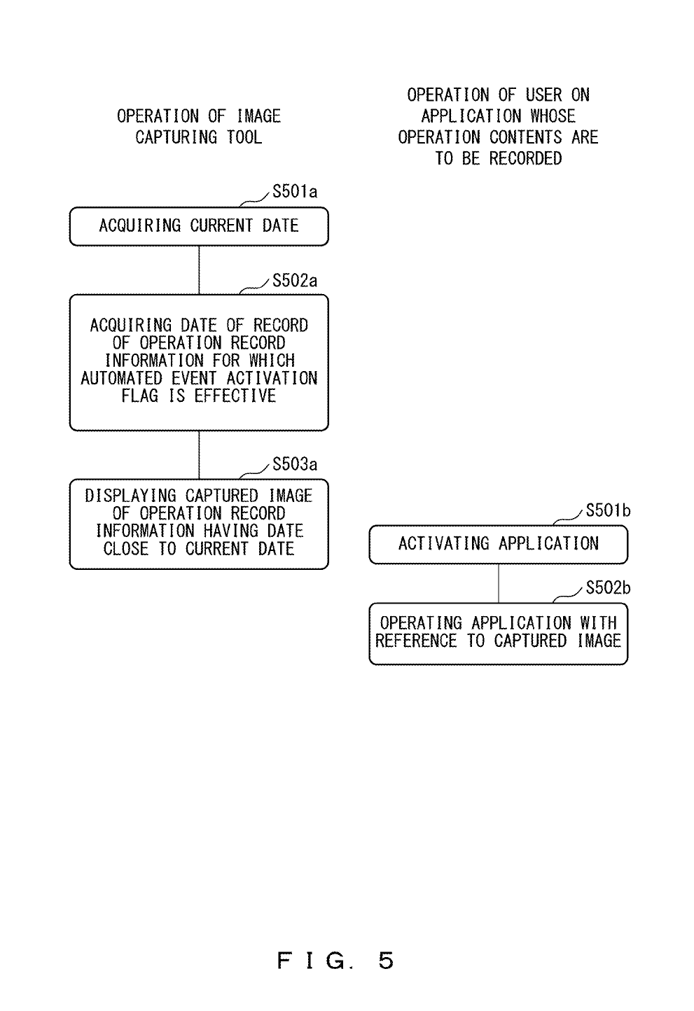

The image capturing tool according to the present embodiment may provide an automated event activating function of automatically displaying the operation record information about the generation date and time close to the current date and time. The switch between valid and invalid for the automated event activating function may be performed using an automated event activation flag. FIGS. 4 and 5 are explanatory view of the outline of the image capturing process of providing the automated event activating function.

FIG. 4 is an explanatory view of the outline of the image capturing process of providing the automated event activating function. Since steps S401a through S406a are the processes similar to those described with reference to steps S201a through S206a, the explanation is omitted here.

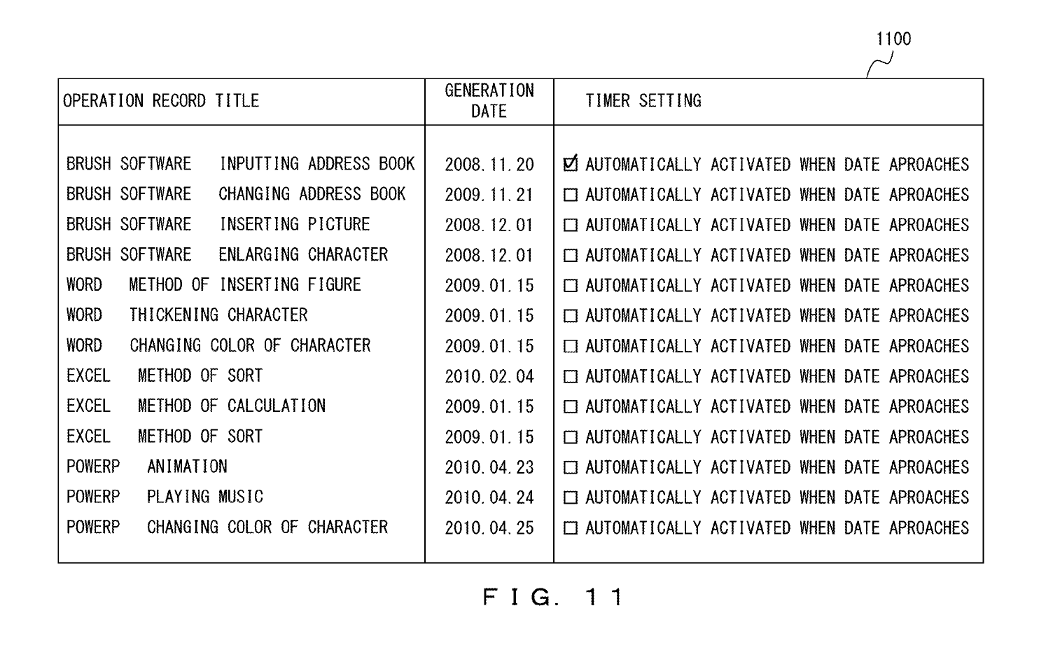

When the title is acquired, the information processing device 1200 displays a setting screen 1100 illustrated in FIG. 11 described later. In the example in FIG. 11, when the user selects preferable operation record information, a check mark is displayed in the column □. The information processing device 1200 makes effective the automated event activation flag of the operation record information selected by the user (step S407a). The information processing device 1200 may be provided with the automated event activation flag for each piece of operation record information. The automated event activation flag may be stored in a specified area in, for example, memory 1202 etc. as described later.

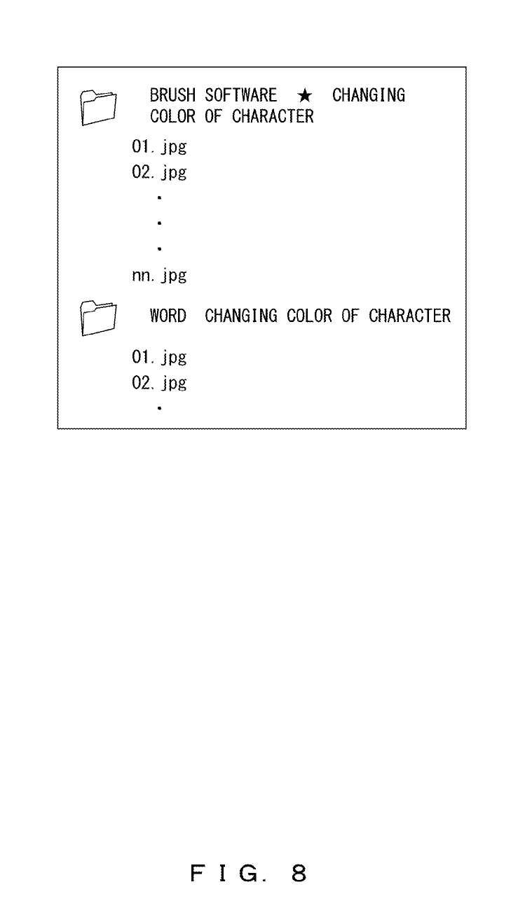

The information processing device 1200 generates a folder having a folder name including an automated event activation flag effective mark ★ and a title acquired in step S406a. For example, as illustrated in FIG. 8, the information processing device 1200 generates a folder having a folder name including “brush software” as the title of the application, “★” as the mark indicating that the automated event activation flag is effective, and “changing the color of a character” as the user input title. Then, the information processing device 1200 stores the captured image acquired in the processes in steps S401a through S405a (step S408a).

When the process in step S408a is performed, the information processing device 1200 passes control to step S402a. Then, the information processing device 1200 repeats the processes in steps S402a through S208a.

FIG. 5 is an explanatory view of the outline of a displaying process of a captured image which provides an automated event activating function. The information processing device 1200 performs the following process according to the image capturing tool.

The information processing device 1200 acquires the current date and time by the timer function provided for the information processing device 1200 (step S501a). Then, the information processing device 1200 acquires the date on which the operation record information for which the automated event activation flag is set as effective was recorded (step S502a). The data on which the operation record information was recorded may be acquired from the generation date and time of the folder which stores the operation record information.

The information processing device 1200 displays the capture of the image of the operation record information close to the current date acquired in step S501a (step S503a). The date close to the current date may be the closest date in the dates after the current date in a specified period from the current date.

When the image capture of the operation record information is displayed, the user activates the application recorded in the displayed operation record information (step S501b) and operates the application while referring to the displayed image capture (step S502b).

FIG. 6 is an example of an operation screen of an image capturing tool.

The operation screen 600 illustrated in FIG. 6 includes a record start button 610, a record end button 620, and a setting button 630.

When the user selects the record start button 610 using a mouse etc., the information processing device 1200 starts recording the operation contents of the user. When the user selects the record end button 620 using a mouse etc., the information processing device 1200 terminates the image capturing process being executed. Furthermore, when the user selects the setting button 630 using a mouse etc., the information processing device 1200 displays the setting screen 1100 illustrated in FIG. 11.

FIG. 7 is an example of a folder storing operation record information.

The name of a folder which stores operation record information may be “name of application: title”. The “name of application” refers to the name of the application whose operation contents are to be recorded. In addition, the “title” is a character string input by a user. The title may include the operation contents of an application. For example, the information processing device 1200 may acquire the title in the process in step S206a illustrated in FIG. 2.

FIG. 7 exemplifies the folder using the name of the appropriate “WORD” and the name of the folder including the title “changing the color of a character”. The folder of “WORD, changing the color of the characters” stores the captured image generated in the process explained with reference to FIG. 2 is stored with the generation order as the file name. In FIG. 7, exemplifies the folder using the names of two applications “paint” and “WORD”, and the name of the folder including the title of “inputting an image”.

Thus, by including the name of an application in the name of a folder which stores operation record information, a table for associating an application and the operation record information about the application is not requested.

FIG. 8 is an example of a folder when an automated event activation flag is effective.

The name of the folder which stores the operation record information may be “name of an application ★ title”. The mark ★ included in the name of the folder is an example of a mark indicating that the automated event activation flag is effective. In the present embodiment, the mark indicating that the automated event activation flag is effective is used, but the mark is not limited to “★”. Various marks including a symbol, a sign, etc. are available as the mark indicating that the automated event activation flag is effective.

FIG. 9 is an example of a listing display screen of operation record information. The information processing device 1200 displays a list of only operation record information which is stored for an application being activated as described above with reference to FIG. 3.

A listing display screen 900 may include a total display button 910 as illustrated in FIG. 9. When the user selects the total display button 910 by a mouse etc., the information processing device 1200 may display the total display screen 1000 for listing all operation record information.

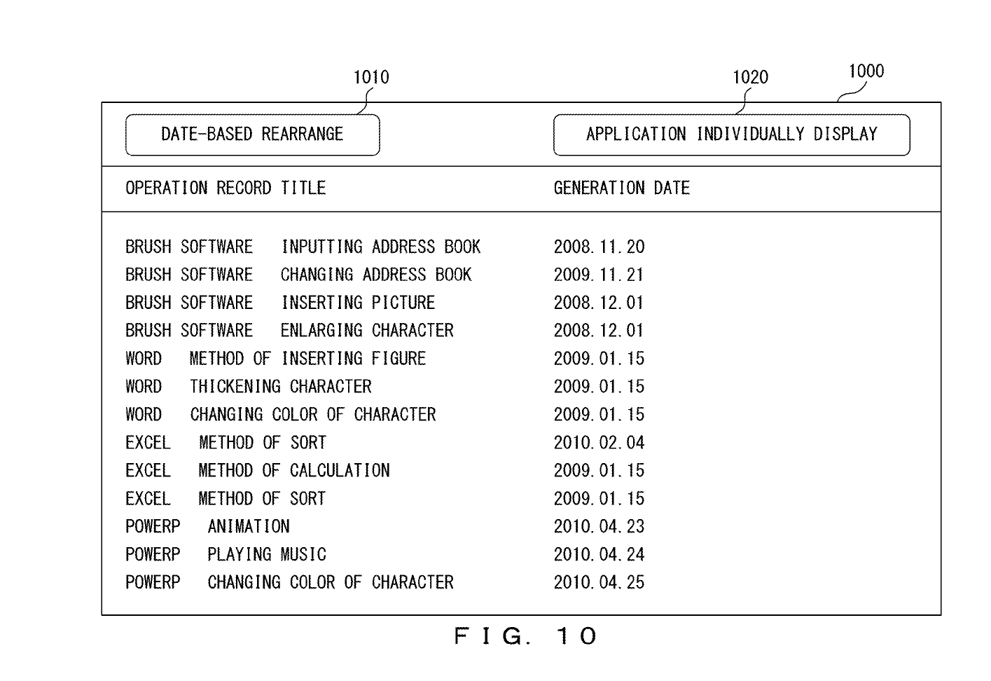

FIG. 10 is an example of the total display screen 1000 for listing all operation record information. The total display screen 1000 illustrated in FIG. 10 lists all operation record information recorded in the information processing device 1200 including the operation record information about the application named “brush software”, the operation record information about the application named “WORD”, etc.

In addition, the total display screen 1000 may include a date-based rearrange button 1010 and an application individually display button 1020 as illustrated in FIG. 10.

When the user selects the date-based rearrange button 1010 by a mouse etc., the information processing device 1200 lists the operation record information displayed on the total display screen 1000 in the order of date after the current date and closer to the current date. However, the year in which the operation record information is generated is not considered in arranging the listing order. FIG. 10 illustrates the total display screen 1000 when the user selects the date-based rearrange button 1010 when the current date is November. In the total display screen 1000 in FIG. 10, the operation record information is listed in order from November as the date of generation. When the user selects the application individually display button 1020 by a mouse etc., the information processing device 1200 displays the listing display screen 900 illustrated in FIG. 9.

FIG. 11 is an example of a setting screen of an automated event activation flag.

The setting screen 1100 illustrated in FIG. 11 displays a list of all operation record information recorded by the information processing device 1200. The setting screen 1100 includes an operation record title, the date of the generation of the operation record information, and a timer setting column. When the user selects the timer setting column of a preferable operation record title, the information processing device 1200 displays a check mark in the timer setting column □ as illustrated in FIG. 11. Then, the information processing device 1200 makes effective the automated event activation flag for the selected operation record information. In the process of making effective the automated event activation flag, performed is the process of changing the name of a folder which stores the selected operation record information into a name including ★, that is, into “name of application ★ title”.

FIG. 12 is an example of a configuration of the information processing device 1200.

The information processing device 1200 illustrated in FIG. 12 includes a CPU 1201, the memory 1202, an input device 1203, an output device 1204, a file system 1205, and a LAN I/F (interface) 1206. These devices are connected through a bus so that data may be communicated with one another.

The CPU 1201 is an arithmetic device which executes a program for realizing the image capturing process according to the present embodiment in addition to controlling peripheral equipment and executing various types of software.

The memory 1202 is a volatile storage device which stores a program etc. for realizing the image capturing process according to the present embodiment. The memory 1202 may be, for example, RAM (random access memory) etc.

The input device 1203 is an external data input device. The input device 1203 maybe, for example, a keyboard, a mouse, etc.

The output device 1204 is a device which outputs data to the display device 1207 etc. The output device 1204 may include the display device 1207.

The file system 1205 is a storage device which stores a program for realizing the image capturing process according to the present embodiment, operation record information, etc. in addition to a program and data to be used in operating the information processing device 1200. The file system 1205 may be one or more non-volatile storage devices such as a magnetic disk storage device. Furthermore, the file system 1205 may include a medium drive device which outputs data in the memory 1202 to, for example, a floppy disk, an MO disk, CD-R, DVD-R, etc., or reads a program, data, etc. from a portable storage medium.

The LAN I/F 1206 is an interface for connection to a network such as the Internet.

A storage medium which may be read to the memory 1202, the file system 1205, and an information processing device for a portable storage medium may be a non-transitory medium. Furthermore, all components illustrated in FIG. 12 are not essential, but some unnecessary components maybe removed from the information processing device 1200, or some components not illustrated in FIG. 12 may be added to the information processing device 1200.

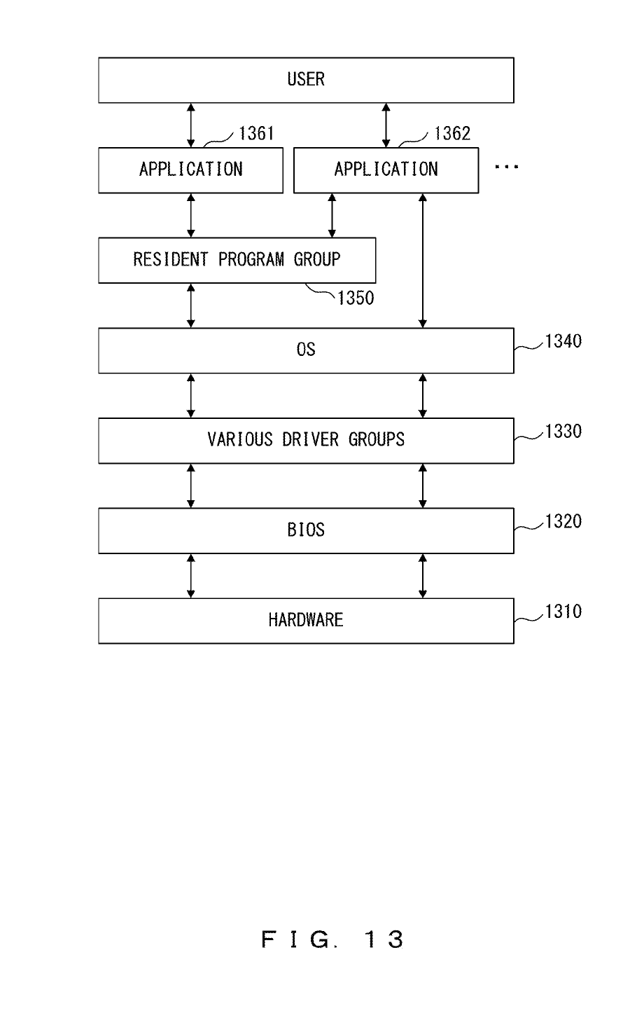

FIG. 13 is an explanatory view of the outline of a system configuration of the information processing device 1200.

A hardware 1310 is the memory 1202, the file system 1205, etc. included in the information processing device 1200.

ABIOS (basic input/output system) 1320 is a program for providing a driver included in a driver group 1330 with a basic operating device for the hardware 1310.

The driver group 1330 is one or more driver groups which provide an operating system (OS) 1340 with an operating device for hardware using the BIOS 1320 etc.

The OS 1340 is an operating system which provides an operating device for hardware using a driver included in the driver group 1330 directly for applications 1361, 1362, . . . or through a resident program group 1350.

The resident program group 1350 is resident in the memory 1202, and constantly operates. Otherwise, it is one or more program groups in a state in which it is immediately operable depending on various events. The image capturing tool according to the present embodiment may belong to the resident program group 1350.

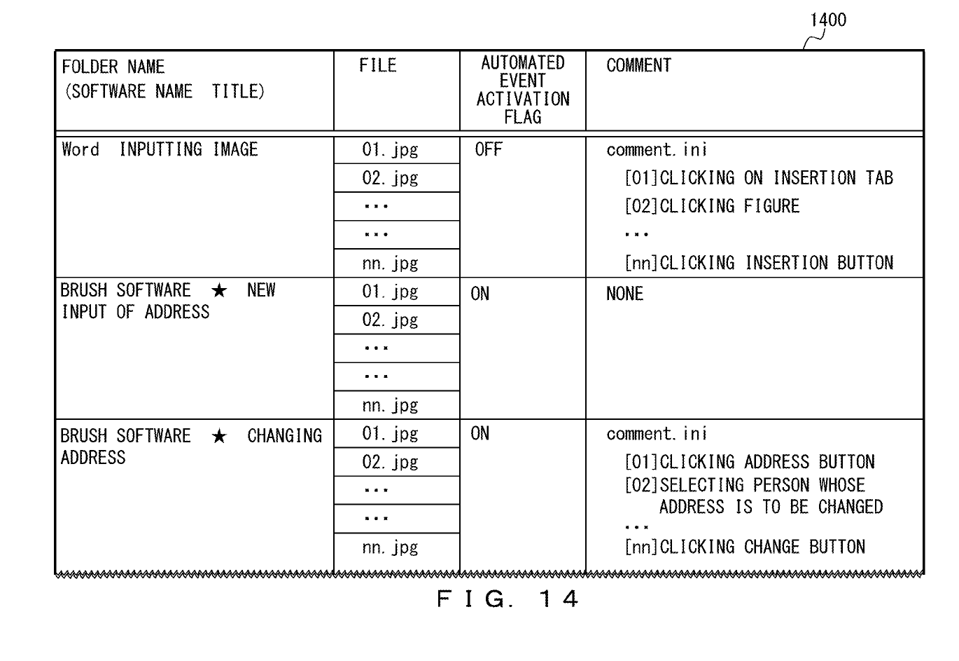

FIG. 14 is an explanatory view of an example of a configuration of operation record information recorded by the information processing device 1200. A table 1400 illustrated in FIG. 14 is a summary of the configuration of the operation record information recorded by the information processing device 1200.

For example, the information processing device 1200 generates a folder under control of the directory “c:¥userdata¥autolog”, and stores a captured image therein. Then, as illustrated in FIG. 14, the information processing device 1200 stores the captured image 01.jpg, 02.jpg, . . . , nn. jpg including the capture order in the file name in the folder which stores the operation record information having the name, for example, “WORD image input”. In this case, nn indicates an integer of 1 or more. Since the name of the folder includes no ★, the automated event activation flag is OFF. The comment corresponding to each captured image is stored in the file “comment.ini”. For example, the file includes the descriptions such as the comment 01 “clicking the insert tab” corresponding to 01.jpg, the comment 02 “clicking the drawing” corresponding to 02.jpg, etc. are recorded in the file “comment.ini”.

Furthermore, for example, the folder of the name “brush software ★ new input of address” stores the captured images 01.jpg, 02.jpg, . . . nn, jpg having the file name including the capture order. In this case, since the folder name includes ★, the automated event activation flag is ON.

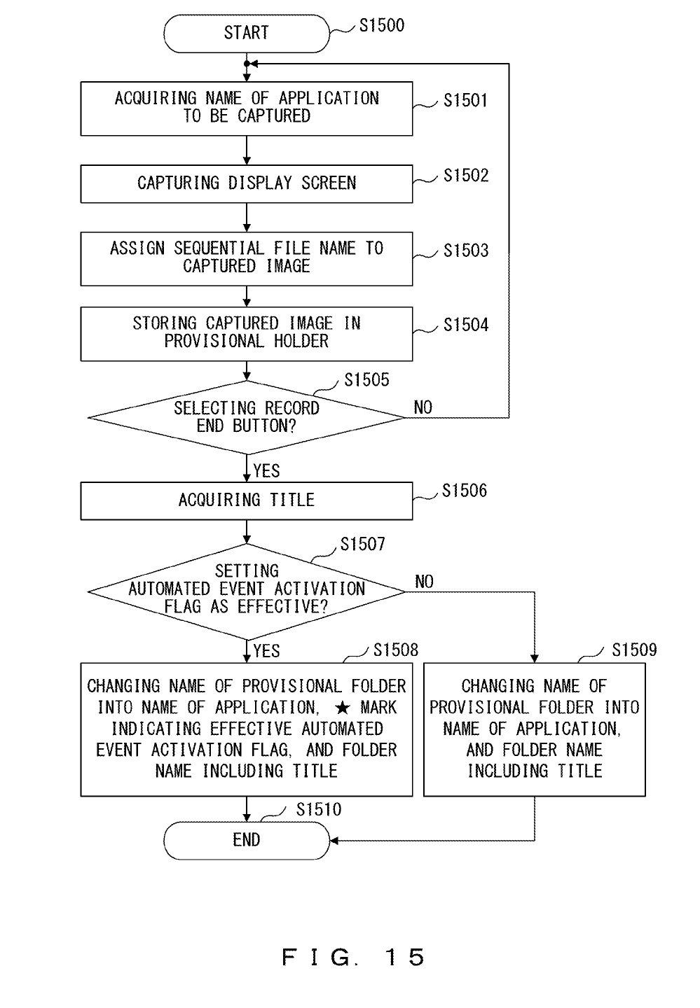

FIG. 15 is a flowchart of an example of an image capturing process by the information processing device 1200.

When the information processing device 1200 detects that the user has selected the record start button 610 of the image capturing tool using a mouse etc., the information processing device 1200 starts recording the operation contents of the user (step S1500).

The information processing device 1200 monitors the activation of an application. When the application is activated by the user, the information processing device 1200 determines that the activated application is a target of the image capturing process. In the description below, the application determined as a target of the image capturing process is referred to a “target application”. The information processing device 1200 acquires the name of the target application (step S1501).

The information processing device 1200 monitors a specified operation of the user, for example, a mouse clicking operation etc. Then, upon detection of the operation of the user, the information processing device 1200 captures the display screen displayed on the display device 1207 (step S1502). The operation of the user to be monitored may be limited to the operation on the target application, or all operations of the user may be defined as monitor targets. The operation on the target application may include the operations on the application and dialog other than the target application that are performed in the operation of the target application.

The information processing device 1200 assigns a sequential file name to a captured image generated in step S1502 (step S1503). For example, the information processing device 1200 assign the file name “01.jpg” to the captured image that is first generated. The captured image that is next generated may be assigned the file name “02.jpg”. It is obvious that a file format other than the joint photographic experts group (JPEG) may be used.

The information processing device 1200 generates a provisional folder in a specified area of the file system 1205. However, if the provisional folder has already been generated, the provisional folder may be used. Then, the information processing device 1200 stores the captured image having a file name in the provisional folder (step S1504).

Unless the information processing device 1200 detects that the user has selected the record end button 620 of the image capturing tool using a mouse etc. (NO in step S1505), the information processing device 1200 passes control to step S1501. In this case, the information processing device 1200 repeats the processes in steps S1501 through S1505.

In addition, if the information processing device 1200 detects that the user has selected the record end button 620 of the image capturing tool using a mouse etc. (YES in step S1505), then the information processing device 1200 passes control to step S1506. In this case, the information processing device 1200 displays the input screen of the title on the display device 1207. Then, the information processing device 1200 acquires the title input by the user on the input screen (step S1506).

The information processing device 1200 displays on the display device 1207 a selection screen on which the validity or invalidity of the automated event activation flag is selected. If the user selects the validity of the automated event activation flag (YES in step S1507), the information processing device 1200 passes control to step S1508. In this case, the information processing device 1200 changes the name of the provisional folder to the folder name including the name of the application acquired in step S1501, the mark ★ indicating that the automated event activation flag is valid, and the title acquired in step S1506 (step S1508).

Setting the validity or invalidity of the automated event activation flag may be performed in advance through the setting screen 1100 illustrated in FIG. 11.

If the user selects the invalidity of the automated event activation flag (NO in step S1507), the information processing device 1200 passes control to step S1509. In this case, the information processing device 1200 changes the name of the provisional folder into a folder name including the name of the application acquired in step S1501, and the title acquired in step S1506 (step S1509).

When the process above is performed, the information processing device 1200 terminates the image capturing process (step S1510).

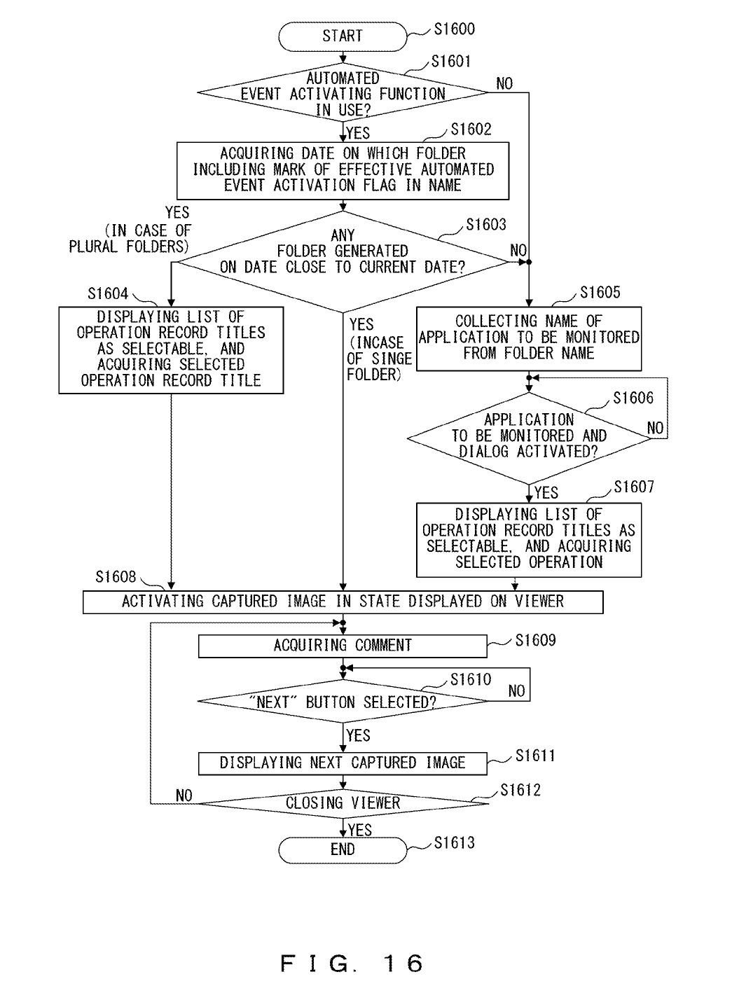

FIG. 16 is an example of a displaying process of operation record information by the information processing device 1200.

When the information processing device 1200 is activated, the information processing device 1200 discriminates whether or not the automated event activating function is being used (step S1601). The information processing device 1200 may discriminate whether or not the automated event activating function is being used by confirming the presence or absence of the folder having the name including the mark ★ indicating that the automated event activation flag is effective.

If no automated event activating function is used (NO in step S1601), the information processing device 1200 passes control to step S1605. If the automated event activating function is being used (YES in step S1601), the information processing device 1200 passes control to step S1602. In this case, the information processing device 1200 acquires the date on which the folder including in its name the mark ★ indicating that the automated event activation flag is effective is generated in the folders stored in a specified area of the file system 1205 (step S1602). In step S1602, the information processing device 1200 acquire only the date, and the information about the year, hour, minute, etc. is not to be acquired.

The information processing device 1200 discriminates whether or not there is a folder generated on the date close to the current date in the folders whose dates are acquired in step S1602 (step S1603). The “date close to the current date” is a date included in the specified period from the current date, for example, one week, one month, etc. from the current date. Therefore, the folder whose date is acquired in step S1602 may include a plurality of folders generated in the date close to the current date.

When a plurality of folders generated on the date close to the current date are included in the folder which acquired the date in step S1602 (YES in step S1603 (plural folders)), the information processing device 1200 passes control to step S1604. In this case, the information processing device 1200 displays on the display device 1207 in the manner in which the folder names of the folder generated on the date close to the current date, that is, a list of operation record titles maybe selected from among the folders which acquired the date in step S1602. If the user selects any in the list of the operation record title displayed on the display device 1207, the information processing device 1200 acquires the operation record title selected by the use, and passes control to step S1608.

When one folder which was generated on the date close to the current date is included in the folder which acquired the date in step S1602 (YES in step S1603 (one folder)), the information processing device 1200 passes control to step S1608.

When there is no folder which was generated on the date close to the current date is included in the folder which acquired the date in step S1602 (NO in step S1603 (one folder)), the information processing device 1200 passes control to step S1605. In this case, the information processing device 1200 acquires the name of the application included in the name of the folder already generated in the process illustrated in FIG. 15 (step S1605). In the description below, the application included in the name of the folder already generated in the process illustrated in FIG. 15 is referred to as an “application to be monitored”.

The information processing device 1200 repeats the process in step S1606 until the activation of the application to be monitored is detected (NO in step S1606). When the activation of the application to be monitored is detected (YES in step S1606), the information processing device 1200 passes control to step S1607. In this case, the information processing device 1200 displays on the display device 1207 so that a selection maybe made from the list of the operation record titles including the name of the application to be monitored. When the user selects any from the list of the operation record titles displayed on the display device 1207, the information processing device 1200 acquires the operation record title selected by the user, and passes control to step S1608.

The information processing device 1200 activates a viewer in the state in which a captured image in the folder detected in step S1603, and the folder having the name including the operation record title selected in step S1604 or S1607 (step S1608). In this case, the information processing device 1200 activates the viewer in the state in which the captured image of “01.jpg” as a file name is displayed. The viewer may include the “next” button. When the information processing device 1200 detects the selection of the “next” button by the user with a mouse etc., the captured image including in the file name the number subsequent to the number included in the file name of the captured image being displayed may be displayed. For example, when the selection of the “next” button is detected while displaying the captured image “01.jpg”, the viewer may display the captured image “02.jpg” including “02” subsequent to “01” in the file name. The viewer may be, for example, a Windows explorer etc.

Depending on the specified operation by the user, the information processing device 1200 displays a comment input screen on the display device 1207. Then, the information processing device 1200 acquires the comment input by the user on the comment input screen (step S1609). The information processing device 1200 associates the acquired comment with, for example, “comment.ini” as explained with reference to FIG. 14 corresponding to the captured image, and stores the comment.

The information processing device 1200 waits for the detection of the selection of the “next” button by the user (NO in step S1610). When the selection of the “next” button by the user is detected (YES in step S1610), the information processing device 1200 displays the captured image including the file name including the number subsequent to the number included in the file name of the captured image being displayed (step S1611).

Unless the instruction of the user to close the viewer is detected (NO in step S1612), the information processing device 1200 repeats the processes in steps S1609 through S1612. When the instruction of the user to close the viewer is detected (YES in step S1612), the information processing device 1200 terminates the displaying process of operation record information (step S1613).

FIG. 15 described above is an example of the image capturing process by the information processing device 1200, but the information processing device 1200 may acquire an operation log simultaneously with or separately from the image capturing process.

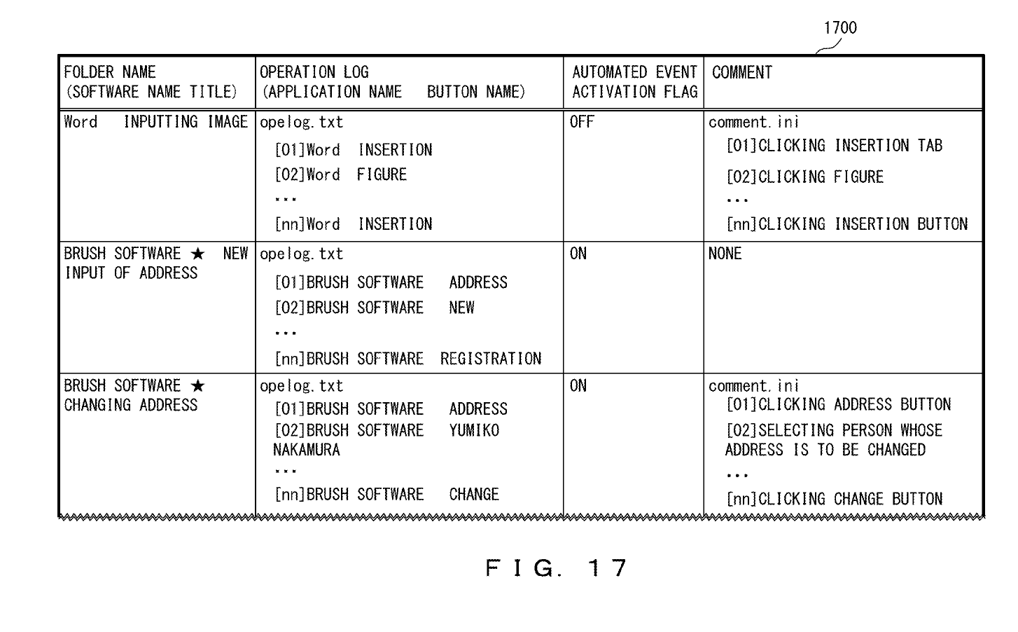

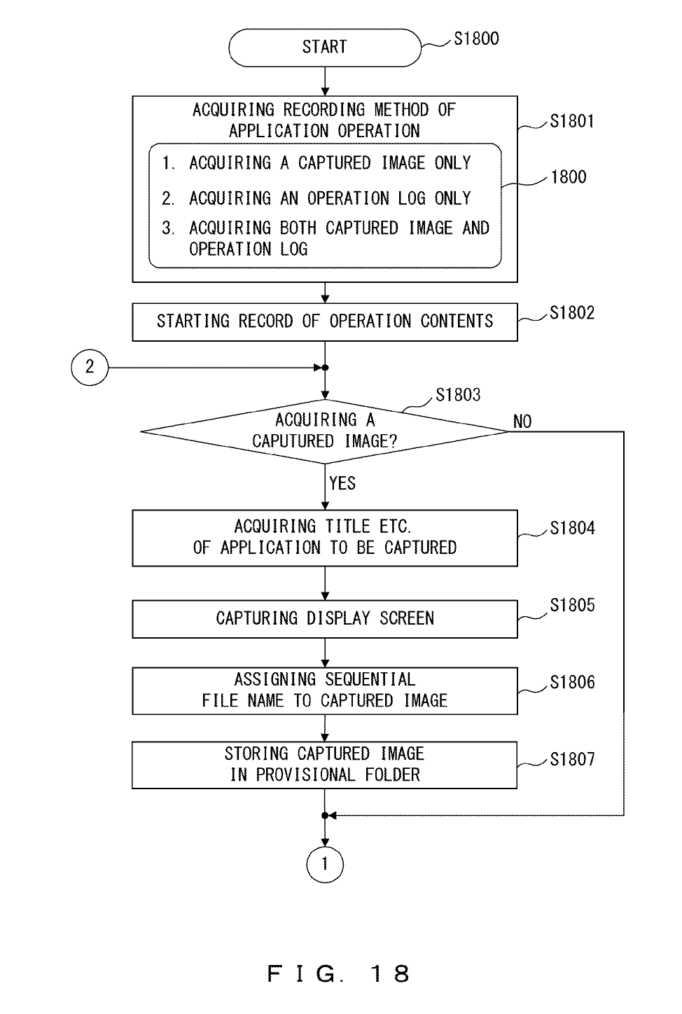

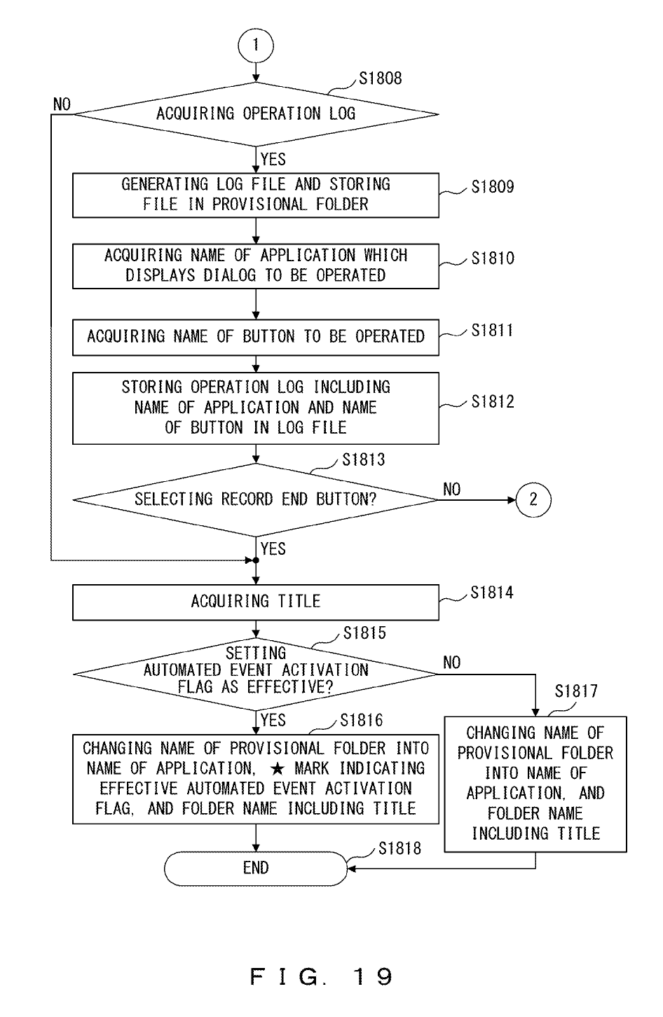

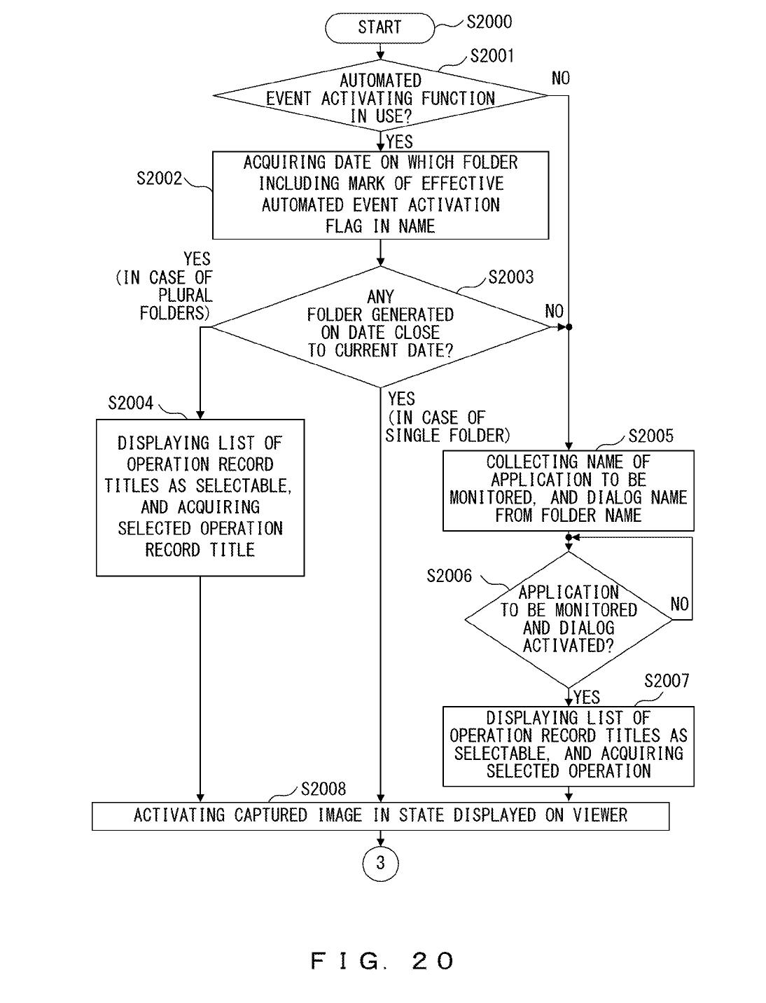

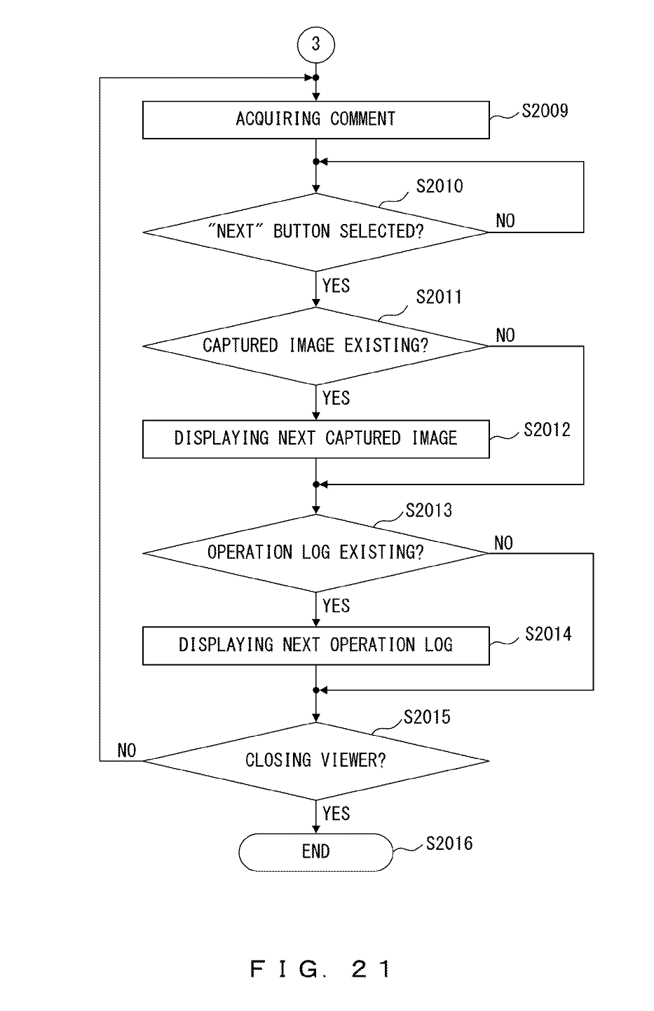

Then, FIG. 17 illustrates the outline of a log file, and FIGS. 18 and 19 are flowcharts of the case in which the information processing device 1200 acquires an operation log simultaneously with or separately from the image capturing process as another example of the image capturing process by the information processing device 1200. In addition, FIGS. 20 and 21 are flowcharts of the displaying process of operation record information including at least one of a captured image and an operation log as another example of the displaying process of operation record information.

FIG. 17 is an explanatory view of a configuration example of a log file when the log file is included in operation record information recorded by the information processing device 1200. A table 1700 illustrated in FIG. 17 is a summary of a part related to a log file in the configuration of the operation record information recorded by the information processing device 1200.

A log file may be stored in the same folder as a captured image. For example, the information processing device 1200 generates a folder under control of the directory “c:¥userdata¥autolog”, and stores a captured image therein. Then, as illustrated in FIG. 17, the information processing device 1200 stores the captured image 01.jpg, 02.jpg, . . . , nn. jpg including the capture order in the file name in the folder which stores the operation record information having the name, for example, “WORD image input”. Furthermore, the information processing device 1200 also stores a log file in the folder which stores the captured image. In the example in FIG. 17, the log file “opelog.txt” is stored in each folder.

The log file stores an operation log corresponding to each captured image. The operation log corresponding to each captured image may include the name of the application which displays the dialog operated when the captured image is generated, and the name of the operated button. For example, when the captured image “01.jpg” generated when the insertion button of the application “Word” is generated, the information processing device 1200 stores the operation log 01 “[01] Word_insertion” in the log file. The automated event activation flag and the comment are explained with reference to FIG. 14. Therefore, the explanation is omitted here.

FIGS. 18 and 19 are flowcharts of an example of a process performed when an operation log is acquired by the information processing device 1200 simultaneously with or separately from the image capturing process.

When the user receives an instruction to perform the image capturing tool by a specified operation, the information processing device 1200 activates the image capturing tool and performs the following process (step S1800).

The information processing device 1200 acquires the method of recording an application operation (step S1801). In step S1801, a selection screen 1800 for a method of recording an application operation is displayed on the display device 1207. For example, the information processing device 1200 displays three options, that is, “1. acquiring a captured image only”, “2. acquiring an operation log only”, and “3. acquiring both captured image and operation log” on the selection screen 1800. When the user acquires the recording method selected by the user from the selection screen, the information processing device 1200 stores the recording method selected by the user in a specified area of the memory 1202.

When the information processing device 1200 detects that the user has selected the record start button 610 of the image capturing tool using a mouse etc., the information processing device 1200 starts recording the operation contents of the user (step S1802). Afterwards, the information processing device 1200 monitors the operation of a specified user, for example, the operation of clicking a mouse etc.

When the user select “2. acquiring an operation log only” in step S1801 (NO in step S1803), the information processing device 1200 passes control to step S1808. In addition, when the user selects one of “1. acquiring a captured image only” and “3. acquiring both captured image and operation log” (YES in step S1803), the information processing device 1200 passes control to step S1804. In this case, the information processing device 1200 performs the processes in steps S1804 through S1807. Since the processes insteps S1804 through S1807 are the same as those described above with reference to steps S1501 through S1504 illustrated in FIG. 15, the explanation is omitted here.

When the user selects “1. acquiring a captured image only in step S1801 (NO in step S1808), the information processing device 1200 passes control to step S1814. In addition, when the user select one of “2. acquiring an operation log only and “3. acquiring both captured image and operation log” in step S1801 (YES in step S1808), the information processing device 1200 passes control to step S1809. In this case, if there is no log file, the information processing device 1200 generates a log file of a specified size, and stores it in the provisional folder generated in step S1807 (step S1809).

When the “2. acquiring an operation log only” is selected in step S1801, the information processing device 1200 acquires the name of the application in which the dialog to be operated is displayed when the operation of the user is detected (step S1810). Furthermore, when “3. acquiring both captured image and operation log” is selected in step S1801, the information processing device 1200 acquires the name of the application in which the dialog to be operated in step 1805 is displayed (step S1810). Furthermore, the information processing device 1200 acquires the name of the operated button, for example, the button clicked with a mouse (step S1811).

The information processing device 1200 stores in the log file generated in step S1809 the operation log including the name of the application acquired in step S1810, and the name of the button acquired in step S1811 (step S1812). When “3. acquiring both captured image and operation log” is selected in step S1801, the information processing device 1200 associates the captured image generated in step S1805 with the operation log, and stores them in the log file.

Unless the information processing device 1200 detects that the user has selected the record end button 620 of the image capturing tool using a mouse etc. (NO in step S1813), the information processing device 1200 passes control to step S1803. In this case, the information processing device 1200 repeats the processes in steps S1803 through S1813.

In addition, when the information processing device 1200 detects that the user has selected the record end button 620 of the image capturing tool using a mouse etc. (YES in step S1813), the information processing device 1200 passes control to step S1814. In this case, the information processing device 1200 performs the processes in steps S1814 through S1818. The processes insteps S1814 through S1818 are the same as those explained with reference to steps S1506 through S1510. Therefore, the explanation is omitted.

FIGS. 20 and 21 are flowcharts of an example of a displaying process of operation record information including at least one of a captured image and an operation log. When the information processing device 1200 is activated, the information processing device 1200 performs the processes in steps 2001 through S2007. Since the processes insteps S2001 through S2007 are the same as those explained with reference to steps S1601 through S1607, the explanation is omitted here.

The information processing device 1200 activates the viewer in the state in which the captured images and the operation logs of the folder detected in step S2003 and the folder including in the name the operation record title selected in step S2004 or S2007 are displayed (step S2008). In this case, the information processing device 1200 activates the viewer in the state in which at least one of the captured image having the file name “01.jpg” and the operation log corresponding to the captured image having the file name “01.jpg” is displayed. When there are both captured image and operation log, the information processing device 1200 activates the viewer in the state in which the captured image and the operation log are displayed. If one of the captured image and the operation log exists, the information processing device 1200 activates the viewer while displaying the captured image or the operation log whichever exists.

In the description below, the folder detected in step S2003, and the folder including in the name the operation record title selected in step S2004 or S2007 are referred to as a “target folder”.

Depending on a specified operation by a user, the information processing device 1200 displays a comment input screen on the display device 1207. Then, the information processing device 1200 acquires the comment input by the user on the comment input screen (step S2009). The information processing device 1200 stores the acquired comment in, for example, “comment.ini” etc. with the comment associated with the captured image and the operation log.

The information processing device 1200 waits until it is detected that the user has selected the “next” button (NO in step S2010). When the information processing device 1200 detects that the user has selected the “next” button (YES in step S2010). When it detects that the user has selected the “next” button (YES in step S2010), the information processing device 1200 passes control to step S2011. If there is a captured image not displayed in the target folder (YES in step S2011), the information processing device 1200 displays on the display device 1207 the captured image having the file name including the number subsequent to the number included in the file name of the captured image being displayed (step S2012). On the other hand, when there is no captured image in the target folder, or no captured image which has not been displayed (NO in step S2011), the information processing device 1200 passes control to step 2013.

If there is an operation log not displayed yet in the target folder (YES in step S2013), the information processing device 1200 displays the operation log stored subsequent to the operation log being displayed (step S2014). However, when there is an operation log corresponding to the captured image displayed in step S2012, the information processing device 1200 displays the operation log corresponding to the captured image displayed in step S2012. In addition, when there is no operation log in the folder, or no operation log not displayed yet (NO in step S2013), the information processing device 1200 passes control to step S2015.

Unless the information processing device 1200 detects the operation of the user the viewer by the user is closed (NO in step S2015), the information processing device 1200 passes control to step S2009. Then, the information processing device 1200 repeats the process in steps S2009 through S2015. In addition, when the information processing device 1200 detects that the operation of the user the viewer by the user is closed (YES in step S2015), the information processing device 1200 terminates the displaying process of operation record information (step S2016).

In the explanation above, an example of the case in which the target of generating operation record information is an operation on the application is described, but the target is not limited to the operation on the application. For example, the operation for a dialog may be a target of generating operation record information.

As described above, the information processing device 1200 generates a captured image on the display screen each time an operation on an application to be recorded is detected. Then, the information processing device 1200 stores the operation record information including the generated captured image in the folder having the folder name including the name of the application to be recorded. That is, the information processing device 1200 associates the operation record information with the application to be recorded, and stores them. On the other hand, when the user activates the application, the information processing device 1200 displays a list of the operation record information recorded relating to the activated application. The list displays only the operation record information relating to the activated application. As a result, the information processing device 1200 may allow the user to easily specify preferable operation record information although there are a number of pieces of operation record information relating to various applications stored in the past. Furthermore, the user may easily specify and reference the preferable operation record information about the application only by activating the application to be used.

In addition, the information processing device 1200 displays the image capture of the operation record information having the date close to the current date in the dates in which the operation record information including the effective automated event activating function. Thus, for example, if the automated event activation flag is made effective by recording operation record information when an operation performed once or a small number of times, that is, an operation such as printing new year cards, etc. using a specific application, the same operation may be performed with reference to the image capture in the same period in every year. Furthermore, an operating method of an application which is used only once or several times a year is often easily forgot. However, since the operation is performed with reference to the image capture, the operation performed before may be easily repeated.

As described above, according to the image capture device disclosed by the present invention, preferable record information may be easily specified from among plural pieces of record information obtained by recording image data on the display screen.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An image capture device comprising:
a processor
which specifies an application to be recorded based on timing with which the application is activated, and detects a specified operation for the application to be recorded;
generates image data on a display screen each time the specified operation for the application to be recorded is detected, associates the generated image data with the application to be recorded, and stores the generated image data and the application to be recorded as record information in a storage unit;
extracts from one or more pieces of record information stored in the storage unit the record information associated with the detected application upon detection of activation of the application, and lists the record information; and
displays image data included in any record information in the listed record information.

2. The device according to claim 1, wherein
the processor displays record information associated with a specified application when a current date is a specific date.

3. The device according to claim 1, wherein
the processor lists record information in order from record information having storage date closer to a current date.

4. The device according to claim 1, wherein
the processor generates an operation log for the specified operation which has been detected each time the specified operation is detected on the application to be recorded, associates the generated operation log with the image data, and stores the log in the storage unit.

5. The device according to claim 1, wherein
the processor stores record information in the storage unit in a state while maintaining the order in which image data included in record information is generated.

6. The device according to claim 5, wherein
the processor displays image data included in any record information in the listed record information at request from a user in order of generation.

7. The device according to claim 1, wherein
when the processor detects an application activated with specified timing, the processor specifies the detected application as the application to be recorded.

8. A method for capturing an image, the method comprising:
specifying by a processor an application to be recorded based on timing with which the application is activated, generating image data on a display screen each time the specified operation for the application to be recorded is detected, associating the generated image data with the application to be recorded, and storing the generated image data and the application to be recorded as record information in a storage unit;
extracting by the processor from one or more pieces of record information stored in the storage unit the record information associated with the detected application upon detection of activation of the application, and listing the record information; and
displaying by the processor image data included in any record information in the listed record information.

9. A computer-readable recording medium having stored therein a program for causing a computer to execute a process comprising:
specifying an application to be recorded based on timing with which the application is activated, generating image data on a display screen each time the specified operation for the application to be recorded is detected, associating the generated image data with the application to be recorded, and storing the generated image data and the application to be recorded as record information in a storage unit;
extracting from one or more pieces of record information stored in the storage unit the record information associated with the detected application upon detection of activation of the application, and listing the record information; and
displaying image data included in any record information in the listed record information.
